(19) United States
(12) Patent Application Publication
(10) Pub. No.: US 2003/0059663 A1
(43) Pub. Date: Mar. 27, 2003

(54) Apparatus for water treatment having electrodeionization device

(76) Inventor: Yoshiteru Misumi, Tokyo (JP)

Correspondence Address: KANESAKA AND TAKEUCHI, 1423 Powhatan Street, Alexandria, VA, 22314, US

(21) Appl. No.: 10/252,422

(22) Filed: Sep. 24, 2002

(30) Foreign Application Priority Data
Sep. 27, 2001 (JP) 2001-297290

(51) Int. Cl. H01M 8/04

(52) U.S. Cl. 429/34; 429/22; 204/660

(57) ABSTRACT

An apparatus 40 for water treatment has an electrodeionization device 34 to which power is supplied from a cell stack 30 of a fuel cell. The direct current power is transformed in its voltage by a transformer 35 and then supplied to the electrodeionization device without passing through an inverter. Efficiency of power supply is improved, and the apparatus is reduced in its equipments costs and a scale thereof. The apparatus 40 treats water from and relating to the fuel cell such as water produced by reaction of oxygen and hydrogen on the cathode, cooling water of the cell stack, water for steam fed to the reformer, and so on.

### FIELD OF THE INVENTION

The present invention relates to an apparatus for water treatment having an electrodieonization device and a cell stack of a fuel cell for feeding electricity to the electrodeionization device.

### BACKGROUND OF THE INVENTION

A fuel cell such as a phosphoric acid fuel cell and a polymer electrolyte fuel cell scarcely pollutes the environment and has a high energy transforming efficiency.

FIG. 2 shows a diagram of a conventional phosphoric acid fuel-cell system. The fuel-cell system 1 includes a fuel cell 7 having cells 5, in which an anode 3 and a cathode 4 are arranged with an electrolyte therebetween. The cells 5 and a cooler for cooling the cells 5 are installed in the fuel cell 7.

A fuel such as a natural gas is fed to a reformer 11 via piping 10, and the fuel reacts with water fed via piping 12 and is reformed to a gas mainly consisting of hydrogen. Combustion air is introduced via piping 13, 13A to the reformer 11. Unreacted fuel taken out of the anode and consisting mainly of hydrogen is also introduced to the reformer 11 to react and produce heat for proceeding the endothermic reforming reaction. The reformed gas is introduced to a shift converter 15 where carbon monoxide in the reformed gas is transformed, and the transformed gas is charged to the anode 3 via piping 16. Combustion gas is discharged from the reformer 11 and fed to a condenser 19 via piping 17, 18.

Air is fed to the cathode 4 via piping 13, 13B, and the reformed gas charged to the anode 3 is oxidized electrochemically by the air to generate electricity. The exhaust gas from the cathode 4 is fed to the condenser 19 via piping 20, 18. The condensate of the condenser 19 is fed to an apparatus 22 for water treatment through piping 21, and the exhaust gas thereof is discharged via piping 19A.

Steam for reforming the fuel in the reformer 11 is fed through the piping 12 from a steam separator 23.

Condensed water in the separator 23 is fed to the cooler (heat exchanger) 6 as cooling water through piping 24, and the water heated in the cooler is returned to the separator 23 through piping 27. The cooler 6, the condenser 23 and the piping 24, 27 constitute a cooling system for the fuel cell. Water treated by the apparatus 22 for water treatment is fed temporarily as supply water to the cooling system via piping 25.

Blow down water from the cooling system is also introduced through piping 29 provided with a heat exchanger 28 to the apparatus 22 and treated therein.

The condensate condensed in the condenser 19 includes impurities such as carbonic acid produced in the reformer 11 and the shift converter 15. The blow down water from the steam separator 23 also includes impurities produced in the system.

The cooling water fed to the cooler 6 should have a low conductivity for electrical insulation and corrosion inhibition of the cooling system of the fuel cell.

The apparatus 22 for water treatment therefore should remove efficiently the impurities and ions contained in the water which is fed to the cooling system.

The apparatus 22 treats the water first by filtering it with a (micro filter) to remove solid substances and flowing it through an activated carbon (tower) to remove organic substances, and finally deionizing it by ion exchanging resins or an electrodeionization device.

The electrodeionization device includes anion-exchange membranes and cation-exchange membranes. The membranes are alternately arranged in such a manner as to alternately form concentrating compartments and desalting compartments, whereby the space between the anion-exchange membrane and the neighboring cation-exchange membrane forms the concentrating compartment, and the space between the cation-exchange membrane and another neighboring anion-exchange membrane forms the desalting compartment. The desalting compartments are filled with a mixture of cation-exchange resins and anion-exchange resins.

Ions flowing into the desalting compartments react with the ion exchange resin according to the affinity, concentration, and mobility of the ions and move through the resin in a direction of potential gradient. The ions further pass through the membranes to hold neutralization of charges in all of the compartments. The ions decrease in the desalting compartments and increase in the concentrating compartments because of the selective-permeability of ions of the membranes and the polarities of potential gradient. This means that cations permeate the cation-exchange membranes and anions permeate the anion-exchange membranes so that the cations and anions are concentrated in the concentrating compartments. Therefore, deionized water is recovered from the desalting compartments. The electrodeionization apparatus does not need regeneration which is necessary for ion exchange resins, and can achieve complete continuous operation, so that the electrodeionization apparatus has good effect such as to obtain water of extremely high purity.

The concentrating compartments may be filled with a mixture of the cation-exchange resins and the anion-exchange resins as like as desalting compartments in order to improve conductivity therein

FIG. 3 shows an electricity supply system from a fuel cell. A direct current from a cell stack 130 of the fuel cell is inverted to alternating current by a D/A inverter 131 and then supplied to an electricity consumer 132. A part of the alternating current from the inverter 131 is converted to direct current by a direct current power supplier 133 having a transformer of voltage and a rectifying device and supplied to an electrodeionization device 134.

Inverting the direct current from the cell stack 130 to the alternating current and converting it to the direct current results a large loss of electricity and reduces efficiency. The direct current power supplier 133 is expensive in costs.

### SUMMARY OF THE INVENTION

The apparatus for water treatment of the invention has an electrodeionization device where direct current electricity generated by a cell stack of a fuel cell is supplied without inverting to alternating current and rectifying it again to direct current.

The water treatment apparatus of the invention does not need the DC power supplier 133, and the loss of electricity is avoided.

The water treatment apparatus of the invention can be employed suitably for treatment of water from and/or relating to a fuel cell and a fuel-cell system.

### BRIEF DESCRIPTION OF THE DRAWINGS

FIGS. 1a and 1b are diagrams of a water treatment apparatus of the preferred embodiments;

FIG. 2 is a diagram of a phosphoric acid fuel cell;

FIG. 3 is a diagram of a conventional water treatment apparatus for a fuel-cell system; and

FIG. 4 is a diagram of a cell stack of a fuel cell and a controlling device.

### DETAILED DESCRIPTION OF THE PREFERRED EMBODIMENTS

The water treatment apparatus 40 of the embodiments has a fuel cell stack 30, direct current electricity of which is supplied to an electrodeionization device 34 without inverting it to alternating current or converting again to direct current. The direct current electricity from the fuel cell stack 30 can be supplied to the electrodeionization device 34 either as-generated or in decreased voltage.

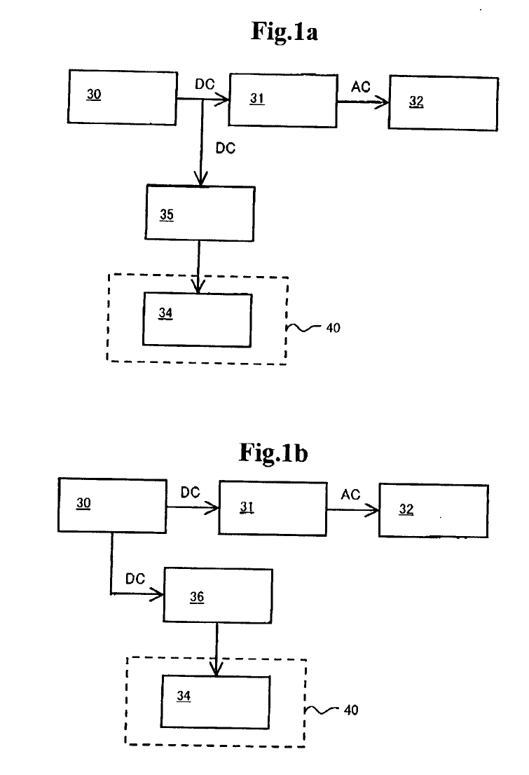

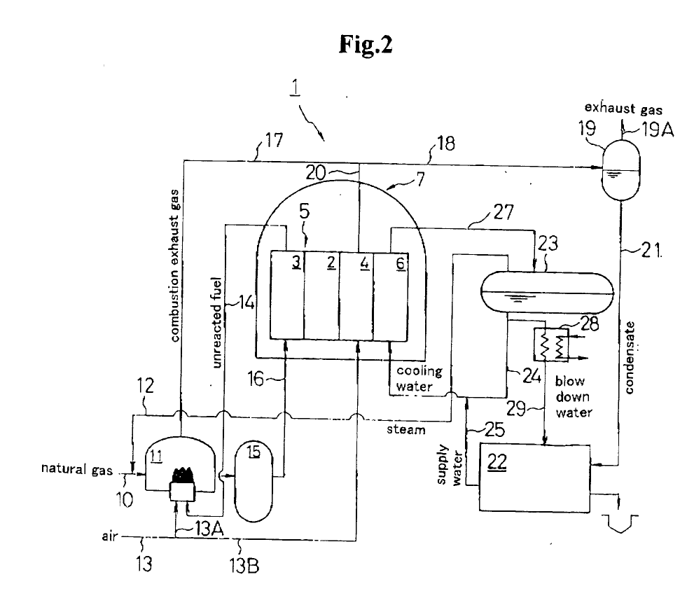

In FIG. 1a where the direct current of the fuel cell is too high in voltage, it is decreased by a transformer 35 and then fed to the electrodeionization device 34 of the water treatment apparatus 40. A part of the direct current from the cell stack 30 of the fuel cell is inverted to alternating current by an inverter 31, and supplied to a power consumer 32.

In FIGS. 1b and 4, direct current is taken out from a part of the entire cell stack 30 whereby the voltage of the direct current is lower than that taken out from the entire cell stack 30, and the direct current having the lower voltage is fed to the electrodeionization device 34. A controlling device 36 controls the number of the cells 30a of the cell stack 30 from which the electricity is taken out in order to change the voltage of the direct current supplied to the electrodeionization device 34. Increasing the number of the cells 30a increases the voltage of the direct current supplied to the electrodeionization device 34, and decreasing the number of the cells 30a decreases the voltage. The voltage is in proportion to the number. For example, a stack of eighty cells 30a supplies direct current of 40V to the device 34, when one cell 30a generates 0.5V. A stack of one hundred and twenty cells 30a, each of which generates 0.5V, supplies direct current of 60V to the device 34.

The transformer 35 and the controlling device 36 are both less expensive and smaller in size thereof than the DC power supplier 133, so that they reduces costs and scales of the fuel-cell system and the water treatment apparatus. The system and the apparatus provided with the transformer 35 or the controlling device 36 are free from the power loss due to D/A and A/D conversion, and are superior in the efficiency of the electricity supply to the electrodeionization device.

The apparatus for water treatment of the invention is suitable for treating water from and relating to the fuel cell such as water produced by reaction of oxygen and hydrogen on the cathode, cooling water of the cell stack, water for steam fed to the reformer, and so on, but not limitative thereto.

### EXAMPLES

an

### Comparative Examples

Without further elaboration, it is believed that one skilled in the art, using the preceding description, can utilize the present invention to its fullest extent. The following embodiments are, therefore, to be construed as merely illustrative, and not limitative in any way whatsoever, of the remainder of the disclosure.

The present invention is further illustrated by the following Examples.

A water treatment apparatus according to the embodiments of the invention and a conventional apparatus were operated. Both apparatuses are provided with an electrodeionization device to which electricity is supplied from a phosphoric acid fuel cell having output power of 200 kW. Each electrodeionization device requires DC power of about 60V×0.1 A.

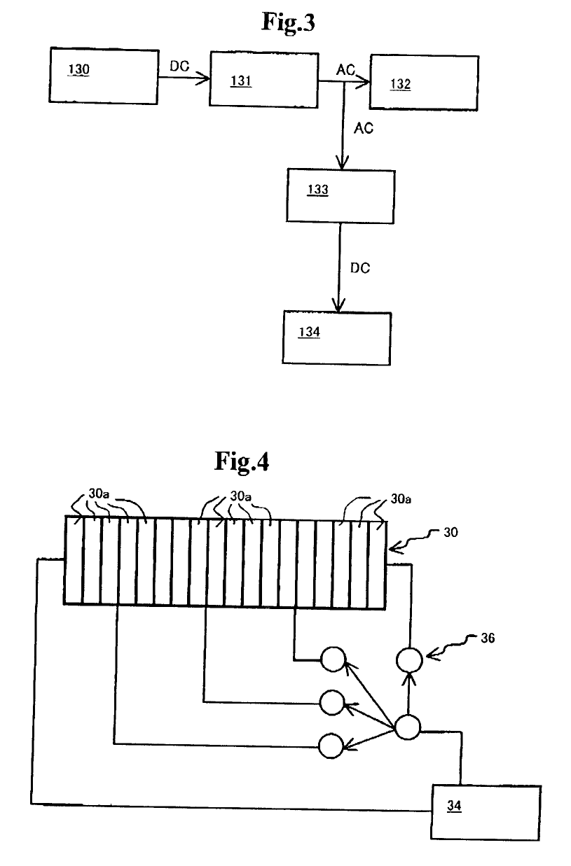

In the conventional apparatus having the diagram of FIG. 3, power of 60V×0.13 A was supplied from the cell stack 130 to the electrodeionization device 134 through the D/A inverter 131 and the A/D converter of the direct current power supplier 133. The power supplier had a size of 230 mm×500 mm×160 mmH and a volume of 18400 cm³.

In the apparatuses according to the embodiments having the diagram of FIG. 1a and that of FIG. 1b respectively , power of 60V×0.1 A was supplied from the cell stack 30 to the electrodeionization device 34 without passing through inverters. The electrodeionization device 34 was exactly the same as the electrodeionization device 134.

The transformer 35 of FIG. 1a had a size of 80 mm×80 mm×70 mmH and a volume of 450 cm³. The controlling device 36 of FIG. 1b had a size of 40 mm×40 mm×70 mmH and a volume of 48 cm³.

Almost the same power as that originally designed for the electrodeionization device was supplied in the apparatuses of Examples 1 and 2 where the DC electricity of the cell stack was not inverted.

On the contrary in Comparative Example where the DC electricity of the cell stack was inverted and converted, more electric power was fed to the electrodeionization device than that originally designed for the electrodeionization device.

The transformer 35 and the controller 36 are much smaller in size than the power supplier 133, so that the scale of the apparatuses can be reduced remarkably in Examples 1 and 2.

As described above, according to the embodiments of the invention, the electricity of the cell stack is supplied to the electrodeionization device without passing through the inverters, and the water treatment apparatus does not need the inverters, and are free from the power loss caused by the D/A inverter and the A/D converter. The apparatus is improved in its efficiency of electricity supply to the electrodeionization device, and is reduced in costs of equipment and in the scale thereof.

The foregoing is considered illustrative only of the principles of the invention. Further, since numerous modifications and changes will readily occur to those skilled in the art, it is not desired to limit the invention to the exact construction and operation shown and described. Accordingly, all suitable modifications and equivalents may be resorted to that fall within the scope of the invention and the appended claims.

What is claimed is:

1. An apparatus for water treatment having an electrodeionization device and a cell stack of a fuel cell,
wherein electricity generated by the cell stack is supplied without passing through an inverter.

2. The apparatus as set forth in claim, 1, wherein the apparatus treats water produced in the fuel cell and water used in a fuel-cell system having the fuel cell.

3. The apparatus as set forth in claim 1, wherein the direct current electricity from the fuel cell is supplied to the electrodeionization device directly.

4. The apparatus as set forth in claim 1, wherein the direct current electricity from the fuel cell is transformed in its voltage and then supplied to the electrodeionization device.

5. The apparatus as set forth in claim 1, wherein the electricity from a part of the cell stack LS supplied to the electrodeionization device.

6. The apparatus as set forth in claim 5, wherein said apparatus has a controller for controlling the number of the cells from which the electricity is supplied to the electrodeionization device.
